(19) United States
(12) Patent Application Publication
(10) Pub. No.: US 2013/0280665 A1
(43) Pub. Date: Oct. 24, 2013

(54) TRANSPORTABLE EQUIPMENT FOR THE THERMAL TREATMENT OF METALS

(71) Applicant: Gianluca Battini, Castel Gabbiano (CR) (IT)

(72) Inventor: Gianluca Battini, Castel Gabbiano (CR) (IT)

(73) Assignee: H.T. SOLUTIONS S.R.L., Vailate (CR) (IT)

(21) Appl. No.: 13/977,896

(22) PCT Filed: Jan. 12, 2011
(86) PCT No.: PCT/IT11/00008

§ 371 Date: Jul. 1, 2013

(51) Int. Cl. F27D 9/00

(52) U.S. Cl. CPC F27D 9/00
USPC 432/77

(57) ABSTRACT

A portable equipment for the thermal treatment of metal pieces, the equipment comprises a bell (10) enclosing a receiving cavity (20) into which can be inserted one or multiple metal pieces to be thermally treated; further comprising heating means to raise the internal temperature of the receiving cavity (20) to a pre-established value and; further comprising an assembly of thermal exchange (100; 200; 300) to lower the temperature reached inside the receiving cavity (20) in such a way as to operate the pre-established thermal treatment on the pieces; the assembly of thermal exchange (100; 200; 300) being arranged externally to the bell (10) to allow a reduction of the overall dimensions of the device.

### RELATED APPLICATIONS

This application is the National Stage under 35 USC 371 of PCT application PCT/IT2011/000008 with an international filing date of 12 Jan. 2011.

### BACKGROUND OF THE INVENTION

1. Field of the Invention

The present invention relates generally to vacuum furnaces for the thermal treatment of metals and more particularly to an innovative furnace of high efficiency and reduced dimensions, to be both transportable and particularly suitable for the thermal treatment of a small number of pieces.

2. Brief Description of the Prior Art

Equipments for the thermal treatment in vacuum of metals have long been known.

As per FIG. 1, the prior art equipments basically comprise a bell 1 (also called vacuum chamber) having a receiving chamber 2 (also called thermal treatment chamber) into which the piece or pieces to be treated is/are positioned. The receiving chamber 2 operates in vacuum conditions, that is an internal depression is generated varying from 10⁻² (ten at the power of minus two) millibar up to values of ten at the power of minus five millibar (10⁻⁵). The vacuum is essential in these processes since it avoids the initiation of the oxidation phenomena due to the presence of oxygen.

The thermal operations that can be performed are multiple and can comprise, for example, hardening, brazing, tempering, ageing, annealing, stress relieving, solution heat-treatment or similar operations.

The bell 1, for obvious reasons of vacuum, therefore must be structurally dimensioned in an appropriate manner to avoid that the entire structure collapses on itself by means, of the depression created.

Inside the bell, a heating system is included to raise the temperature to the desired value as well as a cooling system. The heating system uses, for example, electrical resistances or burners. The cooling system is obtained through the injection of a gas into the receiving chamber 2. In this manner, once the raising of temperature is realized to take the pieces to the pre-established temperature, the chamber is quickly cooled in such a way as to realize the desired thermal treatment.

Getting more into the detail of FIG. 1, a heat exchanger 3 is therefore arranged into the bell and that includes a coil 4 into which a cooling liquid circulates, generally water. A cooling gas, for example nitrogen, is injected into the chamber through a plurality of nozzles 6 or other openings and is sucked through an engine with fan 5 arranged behind the coil 4 itself in such a way that the gas sucked is forced toward a passage through the coil and therefore in contact with the external surface of the coil itself. In such a manner, the cold gas entering into the chamber 2 exchanges heat with the piece to be cooled (the hot piece yields heat to the gas) and, in turn, the gas heated by the contact with the piece yields heat to the coil during its sucking and it is cooled again. Through a simple closed-cycle circulation, the gas is therefore re-introduced inside the chamber 2 through the openings 6 once cooled, realizing a closed cooling circulation that continues for the necessary time until the completion of the thermal treatment.

The background art shows a technical inconvenience due to the fact that the current configurations include an exchanger 3 integrated inside the bell 1. This causes the dimensions of the bell to be very large while making the reduction of dimensions of it very difficult. If, an excessive reduction of encumbrances should be attempted, the cooling system would result inefficient and hardly realizable. In that sense, the prior art, show equipments of large dimensions to the point that they include working chambers weighting not less that one hundred kilos.

It is therefore evident that, in accordance with the prior art, that the difference of few kilos of weight, causes such equipments not to be transportable, but fixed in a permanently.

### SUMMARY OF THE INVENTION

It is therefore the purpose of the present invention to provide an equipment for the thermal treatment of metals that solves at least in part the above mentioned problems.

In particular, it is the purpose of the present invention to make an equipment for the thermal treatment of metals of reduced dimensions, accessorized with the main instrumentation, in such a way as to result easily transportable and therefore mobile from one place to another.

It is therefore the aim of the present invention to provide an equipment that results structurally simple and that does not require long installation times and functioning tests

These and other aims are therefore achieved by the present equipment for the thermal treatment of metals in accordance with claim 1.

The equipment, as known, includes a bell (10) provided with a receiving cavity (20) into which one or more metal pieces to be thermally treated can be introduced while heating means raise the internal temperature of the receiving cavity (20) at a pre-established value.

The equipment includes an assembly of thermal exchange (100; 200; 300) to lower the temperature reached inside the receiving cavity (20) in such a way as to perform the pre-established thermal treatment on the pieces. Such assembly of thermal exchange (100; 200; 300), in accordance with the invention, is now arranged externally to the bell (10) in such a way as to allow a reduction of its dimensions.

In such a manner, it is therefore possible to make bells of very reduced volume that allow a thermal treatment on a limited number of pieces, without incurring in excessive costs.

Moreover, making such an assembly external to the bell, allows, on one hand, to realize an efficient cooling system without having to increase the dimensions of the bell itself and, on the other hand, to be able to easily make a transportable equipment.

Advantageously, the assembly of the thermal exchange (100; 200; 300) forms a closed circulation path for a cooling fluid injected in the receiving chamber. The closed circulation path comprises a thermal exchanger (30, 60; 230, 260′, 260″, 330, 360′, 360″) directly integrated along the closed circulation path and into which the cooling fluid circulates directly. In such a manner, when the cooling fluid is injected inside the cavity it circulates along the closed circulation from the receiving cavity (20) to the thermal exchanger to lower its temperature, to be then sent again into the bell (10) in such a way as to cause the lowering of temperature of the pieces internally arranged.

Such a closed circulation system of the cooling fluid has the advantage of avoiding the integration of a specific coil into which a second cooling fluid is circulating that, in turn, cools the hot gas that has caused the lowering of temperature of the treated pieces.

Advantageously, the closed circulation path further includes an impeller (50) to force the circulation of the cooling fluid along the closed circuit.

Advantageously, the closed circulation path is made by a feed pipe (40′) connected to the receiving cavity and through which the cooling fluid injected inside the receiving cavity is sucked, by a return pipe (40″) through which the cooling fluid circulated into the receiving cavity is injected again, and by the thermal exchanger (30, 60; 230, 260′, 260″; 330, 360′, 360″) with the impeller (50) interposed between the feed pipe and the return pipe.

Advantageously, a first embodiment of the thermal exchanger (30, 60) comprises a coil pipe (30) connected by an end to the feed pipe (40′) and by the opposite end to the impeller (50) and a forced aeration system (60) arranged with respect to the coil (30) in such a way as to be able to send a cooling air flow against the coil, thus causing the cooling of the fluid circulating inside the pipe that forms the coil.

Advantageously, the coil can be enclosed by a containment box (35) hermetically sealed on one side by a guide channel (61), to guide the cooling air from the forced aeration system (60) toward the coil, and open on the opposite side to allow the exit of the cooling air.

Advantageously, the thermal exchanger (230, 260′, 260″), in a second embodiment of the invention, can comprise an air/water plate exchanger (230) having an inlet (260′) to receive an injected cooling liquid and an exit (260″) through which the heated liquid is expelled.

Advantageously, the plate exchanger (230) is connected on the opposite side to the inlet (40′) and to the outlet (40″) in such a way that the circulating gas can exchange heat inside the exchanger (230) by the injected cooling liquid.

Advantageously, in that case, a further cooling system can be used to lower the temperature of the cooling liquid exiting the plate exchanger.

Advantageously, the cooling liquid of the plate exchanger is inside a closed circuit as well.

Advantageously, in that case, the cooling liquid of the plate exchanger can reach also the bell to cool it externally.

In a third embodiment, the thermal exchanger (330, 360′, 360″) can advantageously comprise an air/water exchanger (330) having an inlet (360′) to allow the injection of a cooling liquid and an outlet (360″) through which the heated liquid is expelled and wherein the said exchanger includes liquid/gas circulation finned pipes to improve the thermal exchange.

Also, in this case, the cooling liquid, for example water, can be forced to circulate in a closed circuit manner without requiring the connection to an external source. In that case, as already said for the second embodiment, it will have to be integrated to an auxiliary cooling system in such a way as to lower its re-circulation temperature and eventually such a liquid will also be able to lower the external temperature of the bell.

### BRIEF DESCRIPTION OF THE DRAWINGS

Further features and advantages of the present equipment for the thermal treatment of metals, according to the invention, will result clearer with the description of some embodiments that follows, made to illustrate but not to limit, with reference to the annexed drawings, wherein:

FIG. 1 shows a thermal bell in accordance with the prior art;

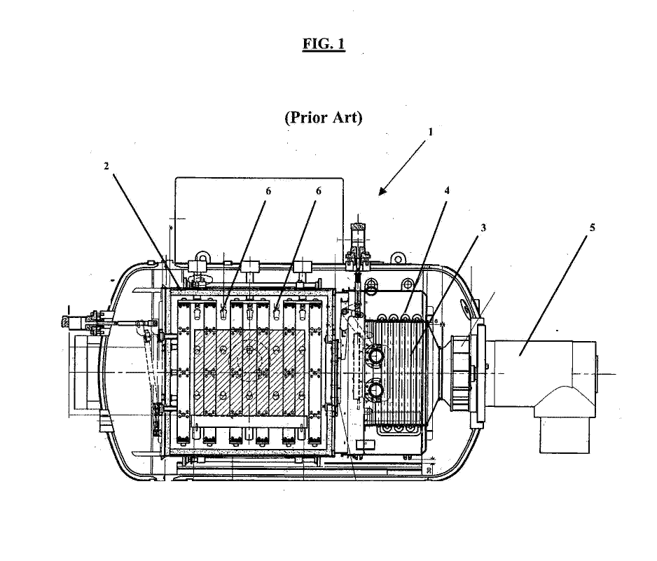

FIG. 2 shows the equipment in accordance with the present invention;

FIG. 3 shows a further view of the equipment of FIG. 2 to highlight the vacuum pump;

FIG. 4 shows a functioning diagram with reference to the first embodiment;

FIG. 5 shows a second possible embodiment;

FIG. 6 shows a third possible embodiment.

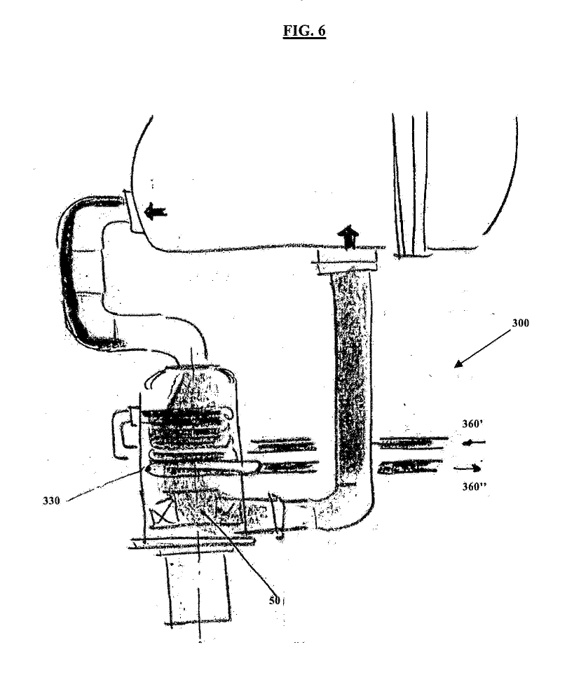

### DETAILED DESCRIPTION OF THE PREFERRED EMBODIMENTS

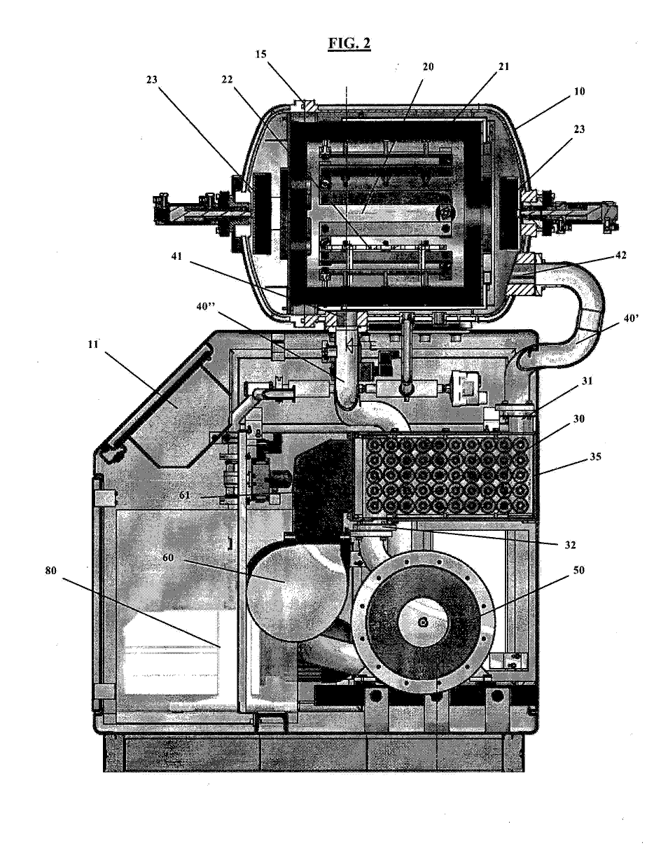

With reference to FIG. 2, a portable equipment is described in accordance with the present invention. A supporting structure 11 supports a bell 10, generally cylindrical. The bell is placed horizontally, with its central axis arranged in parallel to the ground. However, nothing would impede the vertical arrangement of it. Still as shown on FIG. 2, the bell 10 has inside a receiving cavity 20 delimited by lateral walls 21 having an appropriate thickness and made of materials to be able to resist to the depression values and to the temperatures required for the thermal treatments of metals. The receiving cavity 20 includes inside a sort of piece-bearing grate 22 on which the pieces to be thermally treated are arranged. A system of mobile baffles 23, controlled pneumatically for example, appropriately seal the receiving cavity, isolating it from the external environment during the treatment. Such baffles are auxiliary to the maintenance of the internal temperature of the chamber. The bell generally includes an opening similar to a hinged door, like a hatch, to have access to the receiving cavity and naturally closable hermetically. The hermetic closure guarantees the maintenance of the vacuum conditions inside the chamber.

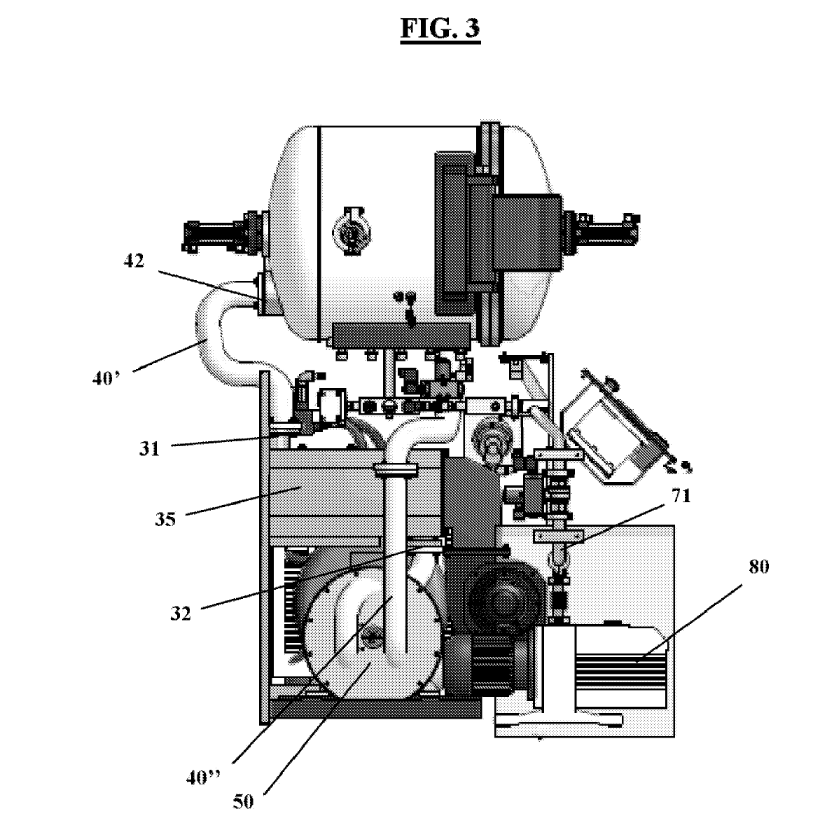

The vacuum, as well known in the prior art, is achieved using a pump 80 visible on FIG. 2 and better highlighted on FIG. 3. The pump is connected to the internal cavity through a pipe 71, as better highlighted on FIG. 3.

An assembly of thermal exchange (40′, 30, 50, 60, 40″) serves to operate the cooling of the gas injected into the receiving chamber and, in accordance with the invention, is in a closed circulation and is arranged externally to the bell in such a way as to be able to reduce its overall dimensions.

A first possible embodiment of the invention is illustrated by the FIGS. 2, 3 and 4 as they describe in detail the configuration of the assembly of the thermal exchange.

FIG. 2 and FIG. 3 show the internal cavity equipped with a first entry point 41 and a second entry point 42 connected to two different points of the chamber (preferably on two opposite sides of the grating 22).

The closed circulation formed by such thermal exchange assembly includes a inlet 40′ connected to the entry point 42, and an outlet 40″ connected to the entry point 41. The inlet and outlet then intercept a cooling block (30, 50, 60) that operates the cooling function, as better described below.

The cooling block includes a coil 30, made of a pipe bent in the shape of a coil to form a thermal exchanger. The coil includes an inlet 31 connected to the Inlet 40′ and an exit 32 connected to a sucking impeller 50. The opposite part of the impeller 50 is then connected to the outlet 40″ (as better highlighted on FIG. 3) to achieve the closed circulation of the cooling fluid forced into the cavity 20 from the inlet 40′ to the outlet 40″.

Still referring to FIG. 2, a forced aeration system 60 includes a suction pump 60 which, operated by a pump, sucks air from the external environment to pipe it through a channel 61 directly to the pipe forming a coil 30. The coil 30, to improve the thermal exchange, is arranged into a containment box 35 to which the channel guide 61 of the forced air sucked by the pump 60 is hermetically connected

The box 35 is therefore open on the opposite side to the connection with the channel 61 to allow the exiting of the air flow.

Still as shown on FIG. 2, the bell 10 includes one or more entries 15 through which a cooling gas is injected into the cavity.

The entire assembly of thermal exchange to achieve the closed circulation as described, is arranged externally to the thermal bell 10 and placed on the support structure 11 which is mobile, for example, through the use of wheels.

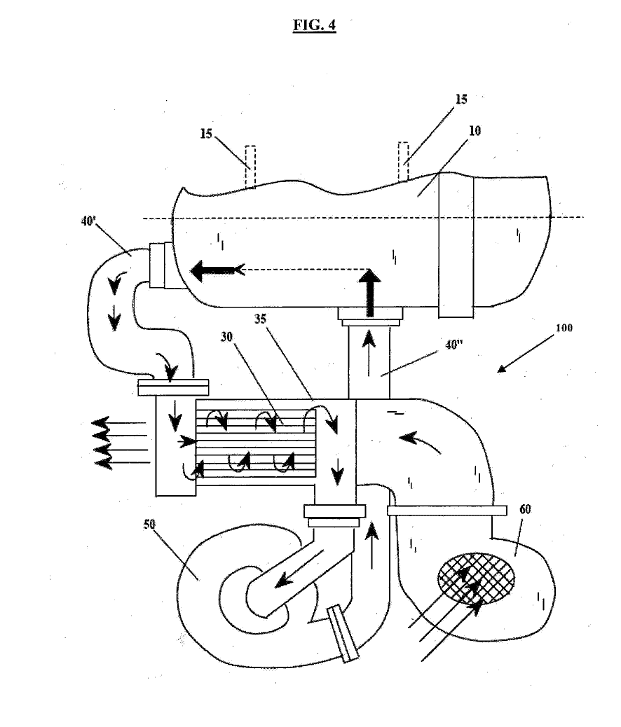

With reference to the flow layout of FIG. 4, having described structurally all the basic elements of such a first embodiment, the following is a description of its functioning.

Once the piece is brought to the required temperature, to operate the cooling, the injection of a cooling gas is achieved through the entries 15 communicating with the bell 10 shown using dotted lines just for descriptive simplicity. The gas injected inside the receiving chamber affects the pieces laid inside the chamber absorbing the heat of them. Contextually, the impeller 50 is causing the cooling gas to be injected inside the receiving cavity and forced to circulate in a closed-cycle manner along the closed circulation path (4O′, 30, 50, 40″) to return to the receiving chamber.

In particular, the cooling gas passes from the inlet 40′ to be injected into the pipe accessing the coil 30 (see direction of the arrows on FIG. 4). The gas therefore circulates inside the pipe of the coil and not externally as per the prior art. In exiting from the pipe forming the coil, the gas goes up, thanks to the suction of the impeller 50, towards the outlet 40″, where it will reach the receiving chamber cooled to start the circulation path again.

The cooling takes place during the flow inside the coil thanks to the forced aeration system 60 which sucks the air from the external environment (see direction of the arrows applied to the grate of the aerator 60) and pumps it via the pipes 20 into the box 35 against the external surface of the coil heated by the circulating internal gas, therefore by actually realizing an air/water thermal exchanger. The air exiting from the box 35 is therefore hot air because it has absorbed the heat of the gas circulating inside the pipe of the coil.

Further advantages of such a solution are therefore evident. In particular, it is not necessary anymore, as per the prior art, an additional water exchanger 3 mounted inside the bell and that is reached by the cooling gas of the metal to lower its temperature. The gas that cools the metal is now directly circulating inside the coil and cooled by a simple aeration system. The whole assembly results in a very simplified structure.

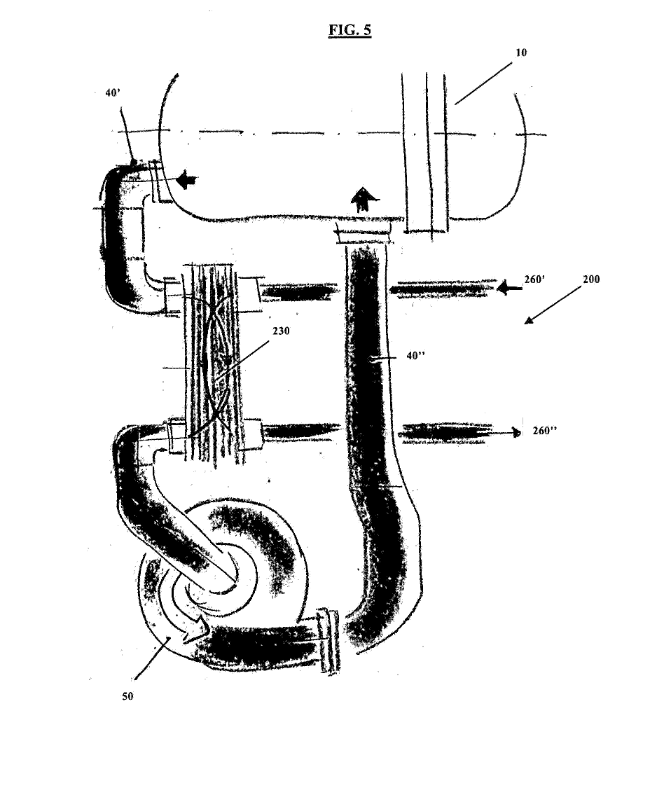

In a second possible embodiment of the invention as shown on FIG. 5, without changing what has been already described up to now, the cooling block includes an air/water plate exchanger 230. In particular, a cooling liquid (for example water) is fed by an inlet 260′ which connects the plate exchanger and exits hot from an outlet pipe 260″. The closed circulation is also achieved, as per the first embodiment, by the outlet 40″, by the cooling block 230 inside which the cooling gas circulates, by the impeller 50 and by the outlet 40″. As already described, the functioning of the cooling block changes since in this case a liquid is injected inside the plate exchanger 230 instead of an air flow being used. The liquid circulating inside the exchanger 230 is sucked through the outlet 260, from which it exits hot since it has absorbed the heat of the hot fluid circulating in a closed circuit (4O′, 230, 50, 30″). Such a solution, which diversifies itself from the previous one by the use of water instead of air, is capable of removing greater quantities of heat. Such a configuration can include the integration of a small auxiliary cooling system to cool the water to be re-circulated. It is not therefore in this way necessary to connect the system to an external water source but, instead, the same water can always be re-circulated and used also for cooling the bell externally.

In a third embodiment of the invention, an air/water exchanger 330 is used which is identical to the previous exchanger 230 except for the fact that finned-pipe type is mounted for improving the thermal exchange.

An ordinary control console allows to operate the entire equipment, which is connected to an external electric power outlet.

1. A transportable equipment for the thermal treatment of metals comprising:
A bell (10) provided with a receiving cavity (20) inside which one or multiple metal pieces to be thermally treated can be inserted;
heating means to raise the internal temperature of the receiving cavity (20) to a pre-established value and;
an assembly of thermal exchange (100; 200; 300) to lower the temperature reached inside the receiving cavity (20) in such a way as to cause the pre-established thermal treatment of the inserted pieces; and wherein said assembly of thermal exchange (100; 200; 300) is arranged externally to said bell (10) in such a way as to allow a reduction of the overall dimensions of said bell.

2. A transportable equipment, according to claim 1, wherein the assembly of thermal exchange (100; 200; 300) forms a closed circulation path for a cooling fluid, said closed circulation path comprising an integrated thermal exchanger (30, 60; 230, 260′, 260″; 330, 360′, 360″) inside which the cooling fluid circulates in such a way that when said cooling fluid is injected inside the cavity (20), the cooling fluid circulates from the receiving cavity (20) to the thermal exchanger to lower its temperature, said cooling fluid is then injected toward the bell (10) to cause the cooling of the arranged pieces inside the receiving cavity (20).

3. A transportable equipment, according to claim 2, wherein said closed circulation path further comprises an impeller (50) to force the circulation of a cooling fluid inside said closed circulation path.

4. A transportable equipment, according to claim from 2, wherein said closed circulation path comprises a inlet (40′) connected to the receiving cavity (20) and through which the cooling fluid is injected inside the receiving cavity (20) and is sucked out through an outlet (40″); said cooling fluid is circulated again into the receiving cavity (20), passing trough the thermal exchanger (30, 60; 230, 260′, 260″; 330, 360′, 360″) sucked by way of the impeller (50) which is mounted between the inlet (40′) and the outlet. (40″)

5. A transportable equipment, according to claim from 4, wherein the thermal exchanger (30, 60) comprises a coil pipe (30) connected by an end to the inlet (40′) and by the other end to the impeller (50), and a forced aeration system (60) arranged with respect to the coil (30) in ‘such a way as to be able to blow a cooling air flow against the coil, thus lowering of the cooling fluid temperature circulating inside the coil.

6. A transportable equipment, according to claim 5, wherein said coil (30) is enclosed by a containment box (35) hermetically sealed on one side by a guide channel (61) to guide the cooling air from the forced aeration system (60) toward the coil; and wherein said containment box (35) is open on the opposite side to allow the exit of the cooling air.

7. A transportable equipment, according to claim 4, wherein the said thermal exchanger (230, 260’, 260″) comprises an air/water plate exchanger (230) having an inlet (260′) to allow the entering of the cooling liquid and an outlet (260″) through which the heated liquid is expelled.

8. A transportable equipment, according to claim 7, further comprising a cooling system to lower the temperature of the cooling liquid exiting said plate exchanger (230).

9. A transportable equipment, according to claim 8, wherein said cooling liquid of the plate exchanger (230) is circulating inside a closed circuit.

10. A transportable equipment, according to claim 8, wherein said cooling liquid of the plate exchanger (230) reaches the bell (10) to cool it externally.

11. A transportable equipment, according to claim 7, wherein said plate exchanger (230) is connected on the opposite side of the inlet (40′) and the outlet (40″) in such a way that the circulating gas can exchange heat inside the exchanger (230) with the injected cooling liquid.

12. A transportable equipment, according to claim 2, wherein said thermal exchanger (330, 360′, 360″) comprises an air/water plate exchanger (330) having an inlet (360′) to allow the entering of the cooling liquid and an outlet (360″) through which the heated liquid is exiting and wherein said exchanger (330, 360′, 360″) includes circulation finned pipes to improve the thermal exchange effectiveness.
